(19) United States
(12) Patent Application Publication
(10) Pub. No.: US 2026/0041131 A1
(43) Pub. Date: Feb. 12, 2026

(54) OIL-IN-WATER-TYPE EMULSIFIED SEASONING

(71) Applicant: IKEDA FOOD RESEARCH CO., LTD., Fukuyama-shi, Hiroshima (JP)

(72) Inventor: Ryota TANAKA, Fukuyama-shi, Hiroshima (JP)

(73) Assignee: IKEDA FOOD RESEARCH CO., LTD., Fukuyama-shi, Hiroshima (JP)

(21) Appl. No.: 19/103,572

(22) PCT Filed: Aug. 29, 2023
(86) PCT No.: PCT/JP2023/031132

§ 371 Date: Feb. 13, 2025

(30) Foreign Application Priority Data
Aug. 30, 2022 (JP) 2022-147437
Dec. 16, 2022 (JP) 2022-212908

(51) Int. Cl. A23L 27/00; A23C 20/02; A23L 11/65; A23L 23/00; A23L 27/10; A23L 27/26

(52) U.S. Cl. CPC A23L 27/80; A23C 20/02; A23L 11/65; A23L 23/00; A23L 27/10; A23L 27/26; A23L 27/88

(57) ABSTRACT

The present invention provides an oil-in-water-type emulsified seasoning having umami and richness and also having suppressed fishy smell as a seasoning which can enhance the umami and richness of non-animal foods and other foods which have light taste and give insufficient impression, and also provides a method for producing the same. An oil-in-water-type emulsified seasoning having umami and richness and also having suppressed fishy smell can be produced by emulsifying a kelp extract and fat/oil in the presence of a water-soluble polymer compound.

### TECHNICAL FIELD

The present invention relates to an oil-in-water-type emulsified seasoning, a method for producing the same, and the like.

### BACKGROUND ART

In recent years, with the growing awareness of health maintenance, animal protection, environmental preservation, and the like, there is a growing need for plant foods with plant raw materials which replace animal raw materials; however, in general, plant foods are known to have lighter taste and less richness than animal foods.

Patent Literature 1 discloses a method for producing an oil-in-water-type emulsified seasoning, including emulsifying soybean protein and fat/oil in the presence of glutathione.

Patent Literature 2 discloses a method for producing an enzyme-treated kelp extract, comprising enzymatically treating an extraction liquid during or after the extraction treatment of kelp in the presence of ethanol using an enzyme with lipase activity.

### CITATION LIST

### Patent Literatures

Patent Literature 1: JP-B-6814375
Patent Literature 2: JP-B-6142355

### SUMMARY OF INVENTION

### Technical Problem

The present invention provides an oil-in-water-type emulsified seasoning having umami and richness and also having suppressed fishy smell as a seasoning which can enhance the umami and richness of non-animal foods and other foods which have light taste and give insufficient impression, and also provides a method for producing the same.

### Solution to Problem

The inventor found that an oil-in-water-type emulsified seasoning having umami and richness and also having suppressed fishy smell can be produced by emulsifying a kelp extract and fat/oil in the presence of a water-soluble polymer compound. Thus, the present invention has been completed.

That is, the present invention relates to the following embodiments [1] to [13].

[1] A method for producing an oil-in-water-type emulsified seasoning, comprising emulsifying a kelp extract and fat/oil in the presence of a water-soluble polymer compound.

[2] The method for producing an oil-in-water-type emulsified seasoning according to [1], wherein the oil-in-water-type emulsified seasoning comprises from 0.1 to 10 parts by weight of the fat/oil per part by weight of the solids content in the kelp extract.

[3] The method for producing an oil-in-water-type emulsified seasoning according to [1] or [2], wherein the oil-in-water-type emulsified seasoning comprises from 0.05 to 5 parts by weight of the water-soluble polymer compound per part by weight of the fat/oil.

[4] The method for producing an oil-in-water-type emulsified seasoning according to any of [1] to [3], the oil-in-water-type emulsified seasoning comprises wherein from 5 to 30 wt. % of the water-soluble polymer compound is contained when the amount of the oil-in-water-type emulsified seasoning is taken as 100 wt. %.

[5] An oil-in-water-type emulsified seasoning comprising a kelp extract, fat/oil, and a water-soluble polymer compound.

[6] The oil-in-water-type emulsified seasoning according to [5], which comprises from 0.1 to 10 parts by weight of the fat/oil per part by weight of the solids content in the kelp extract.

[7] The oil-in-water-type emulsified seasoning according to [5] or [6], which comprises from 0.05 to 5 parts by weight of the water-soluble polymer compound per part by weight of the fat/oil.

[8] The oil-in-water-type emulsified seasoning according to any of [5] to [7], which comprises from 5 to 30 wt. % of the water-soluble polymer compound when the amount of the oil-in-water-type emulsified seasoning is taken as 100 wt. %.

[9] The oil-in-water-type emulsified seasoning according to any of [5] to [8], for use in a plant food and/or drink.

[10] The oil-in-water-type emulsified seasoning according to any of [5] to [9], for use in imparting enhanced umami, imparting enhanced cheese flavor, imparting enhanced cloudiness, imparting enhanced milkiness, imparting enhanced richness, imparting enhanced meaty flavor, imparting enhanced smoothness, or masking.

[11] A food and/or drink comprising the oil-in-water-type emulsified seasoning according to any of [5] to [10].

[12] A plant food and/or drink comprising the oil-in-water-type emulsified seasoning according to any of [5] to [10].

[13] A cheese flavor food and/or drink, a milk flavor food and/or drink, or an emulsified soup and sauce, each comprising the oil-in-water-type emulsified seasoning according to any of [5] to [10].

### Advantageous Effect of Invention

The present invention makes it possible to provide an oil-in-water-type emulsified seasoning having umami and richness and also having suppressed fishy smell, and the seasoning can impart umami, richness, and the like to, for example, non-animal foods and other foods which have light taste and give insufficient impression. The present invention also facilitates a method by which the seasoning can be produced easily.

### DESCRIPTION OF EMBODIMENTS

An embodiment of the oil-in-water-type emulsified seasoning of the present invention contains a kelp extract, fat/oil, and a water-soluble polymer compound.

Further, an embodiment of the production method of the present invention is characterized by emulsifying a kelp extract and fat/oil in the presence of a water-soluble polymer compound.

The kelp extract used in the present invention may be an extract of various dried kelp products.

The type of kelp may be any of Rishiri kelp, Hidaka kelp (Mitsuishi kelp), Saccharina japonica, Rausu kelp, fine kelp, long kelp (Hamanaka kelp), and the like, and these may be used singly or in combination of two or more. A dried kelp product may be used as is, or may be shredded, crushed, or thinly sliced.

The extraction solvent may be water, hot water, or a solvent containing ethanol, and is preferably an aqueous solution with an ethanol concentration of from 1 to 95 wt. %, more preferably an aqueous solution with an ethanol concentration of from 5 to 90 wt. %, and further more preferably an aqueous solution with an ethanol concentration of from 10 to 80 wt. %. While the ratio of solvent and seaweed is not particularly limited, the amount of solvent is preferably from 0.5 to 100 parts by weight, more preferably from 1 to 50 parts by weight, and further more preferably from 2 to 20 parts by weight, per part by weight of kelp. The extraction temperature is preferably from 10 to 120° C., more preferably from 15 to 100° C., and further more preferably from 20 to 90° C. The extraction time is preferably from 1 minute to 24 hours, more preferably from 2 minutes to 12 hours, further more preferably from 5 minutes to 5 hours, and particularly preferably from 10 minutes to 2 hours.

The extraction may be carried out under normal pressure or increased pressure, and it may be conducted by reflux extraction. The kelp raw material can be separated from the liquid part by filtration through a nonwoven fabric or a filter, or by centrifugal separation, and the liquid part can be recovered. A kelp extract obtained by mixing a kelp extract extracted with hot water and a kelp extract extracted with an aqueous ethanol solution may also be used, and it is preferable to use an enzyme-treated kelp extract.

To use an enzyme-treated kelp extract, it may be prepared by the method described in Patent Literature 2, and an extraction liquid during or after the extraction treatment of kelp may be treated with an enzyme with lipase activity. For example, an extraction liquid during the extraction treatment of kelp can be treated with an enzyme with lipase activity, or an extraction liquid after the extraction treatment of kelp can be treated with an enzyme with lipase activity. A liquid part obtained by solid-liquid separation of the extraction liquid may be treated with an enzyme, and it is preferable to perform enzyme treatment in the presence of ethanol. The ethanol concentration is preferably from 0.01 to 60 wt. %, more preferably from 0.1 to 55 wt. %, further more preferably from 0.3 to 45 wt. %, and particularly preferably from 0.5 to 40 wt. %.

The enzyme with lipase activity used in the enzyme treatment may be any enzyme with lipase activity as long as it can be used in food processing. A product containing the enzyme may also be used, and an enzyme preparation can be used. Examples of the enzyme with lipase activity may include lipase preparations, such as Lipase OF (produced by Meito Sangyo Co., Ltd.), Lipase A “Amano” 6 (produced by Amano Enzyme Inc.), and Li-lipase (registered trademark) A-10D (produced by Nagase Chemtex Corporation). The amount of enzyme added can be changed as appropriate depending on the treatment temperature and treatment time, and is, for example, as a preparation, generally from 0.0001 to 1.0 wt. %, preferably from 0.0005 to 0.5 wt. %, and more preferably from 0.001 to 0.2 wt. %.

The treatment temperature in the enzyme treatment is generally from 10 to 70° C., preferably from 15 to 60° C., and more preferably from 20 to 50° C. The treatment time in the enzyme treatment is generally from 10 minutes to 12 hours, preferably from 20 minutes to 8 hours, and more preferably from 30 minutes to 6 hours.

When the amount of the oil-in-water-type emulsified seasoning is taken as 100 wt. %, the content of the kelp extract, as the kelp extract solids content, is preferably from 0.5 to 40 wt. %, more preferably from 1 to 20 wt. %, and further more preferably from 2 to 15 wt. %, from the viewpoint of enhancing the umami and richness of foods and suppressing fishy smell. The water content of the oil-in-water-type emulsified seasoning, as the total amount of extract-derived water and water added, is preferably from 5 to 80 wt. %, more preferably from 10 to 70 wt. %, and further more preferably from 20 to 60 wt. %.

The fat/oil used in the present invention is not particularly limited, and examples thereof may include plant fats/oils, such as palm oil, palm kernel oil, coconut oil, soybean oil, rapeseed oil, sunflower oil, corn oil, olive oil, sesame oil, rice oil, safflower oil, cottonseed oil, peanut oil, linseed oil, perilla seed oil, grape seed oil, perilla oil, and algae oil; animal fats/oils, such as krill oil, fish oil, pork fat, chicken oil, beef tallow, and milk fat; and processed fats/oils thereof (e.g., curing, fractionation, or transesterification). A mixture of two or more fats/oils can also be used. Preferred among these are plant fats/oils, in order to obtain animal-free emulsified seasonings.

From the viewpoint of enhancing the umami and richness of foods and suppressing fishy smell, the content of fat/oil in the oil-in-water-type emulsified seasoning is preferably from 0.1 to 20 parts by weight, more preferably from 0.2 to 10 parts by weight, and further more preferably from 0.5 to 5 parts by weight, per part by weight of the solids content in the kelp extract. When the amount of the oil-in-water-type emulsified seasoning is taken as 100 wt. %, the content of fat/oil is preferably from 2 to 60 wt. %, more preferably from 5 to 50 wt. %, and further more preferably from 10 to 40 wt. %.

The water-soluble polymer compound used in the present invention is not particularly limited as long as it is a water-soluble polymer compound having emulsifying effect, and examples thereof may include protein hydrolysates, modified starches, and the like. Preferred are water-soluble polymer compounds other than gums, such as gum arabic and gum ghatti. The average molecular weight of such a water-soluble polymer compound is more preferably 1 000 or more, and further more preferably 2 000 or more.

Protein hydrolysates are obtained by hydrolyzing proteins with enzymes, heat, acid, alkali, or the like. Examples of raw material proteins for protein hydrolysates may include beans, grains, milk, meat, seafood, algae, microorganisms such as yeast, sake lees, and the like. Specifically, preferred are yeast extract, bean proteins such as soybean protein, and plant proteins such as grain protein and seed and fruit protein. Two or more of these proteins may be used in combination. Commercial products may be used as these protein hydrolysates.

Examples of modified starches may include modified starches having emulsifying effect, such as starch sodium octenyl succinate, phosphate-crosslinked starch, acetate starch, hydroxypropyl starch, and oxidized starch.

These water-soluble polymer compounds may be used singly or in combination of two or more.

From the viewpoint of imparting an emulsion stabilizing effect to the oil-in-water-type emulsified seasoning, enhancing the umami and richness of foods, and suppressing fishy smell, the content of the water-soluble polymer compound in the oil-in-water-type emulsified seasoning is preferably from 0.05 to 5 parts by weight, more preferably from 0.08 to 2 parts by weight, further more preferably from 0.1 to 1 part by weight, and particularly preferably from 0.25 to 0.45 parts by weight, per part by weight of the fat/oil. The content of the water-soluble polymer compound is also preferably from 0.05 to 10 parts by weight, more preferably from 0.1 to 5 parts by weight, and further more preferably from 0.2 to 3 parts by weight, per part by weight of the solids content in the kelp extract. In order to obtain a more stable emulsion, when the amount of the oil-in-water-type emulsified seasoning is taken as 100 wt. %, the content of the water-soluble polymer compound is preferably from 5 to 30 wt. %, more preferably from 7 to 20 wt. %, and further more preferably 7 wt. % or more and less than 15 wt. %.

The oil-in-water-type emulsified seasoning of the present invention may also contain salts, organic acids such as acetic acid and citric acid, other seasonings, antioxidants, emulsifiers such as lecithin, lysolecithin, and polyglycerin fatty acid esters, and the like. The amount of salt to be added is not particularly limited, but is preferably less than 7.5 wt. %, more preferably 7.0 wt. % or less, further more preferably 6.0 wt. % or less, and particularly preferably 5.0 wt. % or less, and is preferably 0.5 wt. % or more, and more preferably 1.0 wt. % or more, when the amount of the oil-in-water-type emulsified seasoning is taken as 100 wt. %.

The emulsification treatment may be performed to mix and homogenize the above components, and can be carried out by a conventional emulsification method. For example, water is added appropriately to a kelp extract, a water-soluble polymer compound is dissolved to prepare an aqueous phase, and the aqueous phase and fat/oil, which is an oil phase, are emulsified by a known emulsification method, thereby preparing an oil-in-water-type emulsified seasoning. Examples of the emulsifier used in the emulsification treatment may include high-speed rotating emulsifiers, such as homogenizers, homomixers, and colloid mills; high-pressure emulsifiers, such as high-pressure homogenizers, microfluidizers, and nanomizers; ultrasonic emulsifiers, membrane emulsifiers, and the like. Two or more of these devices may be used in combination.

The oil-in-water-type emulsified seasoning of the present invention is not particularly limited as long as it is a seasoning which has umami, milky richness, and creamy texture, has suppressed fishy and seaweed flavor, has a cheese-like flavor, has emulsion particles, and has a small emulsion particle size; however, the average particle size of the emulsion particles is preferably from 100 to 3 000 μm, and more preferably from 200 to 2 000 μm. The average particle size of the emulsion particles can be measured with a commercially available particle size analyzer or the like.

The oil-in-water-type emulsified seasoning of the present invention is a seasoning which can impart, to foods and drinks to which the seasoning is added, one or more selected from the group consisting of umami, cheese flavor, cloudiness, milkiness, richness, meaty flavor, or smoothness, and enhance it, and which can also mask bean smell and the like. In particular, the oil-in-water-type emulsified seasoning of the present invention can be used for imparting enhanced umami, imparting enhanced cheese flavor, imparting enhanced cloudiness, imparting enhanced milkiness, imparting enhanced richness, imparting enhanced meaty flavor, imparting enhanced smoothness, or masking. In particular, enhanced umami, cheese flavor, cloudiness, milkiness, richness, meaty flavor, or smoothness can be imparted, and bean smell and the like can be masked, whereby the lack in flavor and unpleasant smell of non-animal foods, particularly plant foods, can be eliminated, and by imparting umami, richness, creamy texture, and the like, seasoning like animal foods and drinks can be achieved. The amount of the seasoning added to each food and/or drink is not particularly limited as long as its seasoning effect can be exhibited, but is preferably from 0.01 to 30 wt. %, more preferably from 0.05 to 20 wt. %, and further more preferably from 0.1 to 10 wt. %.

Foods to which the seasoning is added are not particularly limited as long as umami, cheese flavor, cloudiness, milkiness, richness, meaty flavor, or smoothness can be enhanced, or bean smell and the like can be masked, by the addition of the seasoning. Animal foods and drinks using animal raw materials, or non-animal foods and drinks using non-animal raw materials may be used. In particular, the seasoning is beneficial for plant foods and drinks using plant raw materials, such as plant milk, plant protein, and plant fat/oil. It is possible to prepare cheese flavor foods and drinks, such as cheese and cheese substitutes, milk flavor foods and drinks, such as margarine, white sauce, whipped cream, filling, coffee whitener, pudding, ice cream, yogurt, caramel, milk drinks, plant milk drinks, milk tea, and matcha milk, and emulsified soups and sauces, such as white broth soup, all of which have enhanced umami, cheese flavor, cloudiness, milkiness, richness, meaty flavor, or smoothness, or have masked bean smell and the like.

### EXAMPLES

The present invention will be described in detail below with reference to Examples; however, the present invention is not limited by the following examples. In the present invention, all percentages are wt. %, unless otherwise specified.

### Example 1

50 g of hot water-extracted Saccharina japonica extract (solids content: 15%) (Example 1-1), Rishiri kelp extract (solids content: 15%) (Example 1-2), or Hidaka kelp extract (solids content: 15%) (Example 1-3), 5 g of starch sodium octenyl succinate (Emalstar (registered trademark) 500, produced by Matsutani Chemical Industry Co., Ltd.), and 16 g of palm oil (Palm Ace (registered trademark) 10, produced by Fuji Oil Co., Ltd.) were added and emulsified using a high-pressure homogenizer (40 MPa), thereby obtaining kelp extract oil-in-water-type emulsions of Example Products 1-1 to 1-3.

5 wt. % aqueous solutions of Example Products 1-1 to 1-3 were prepared respectively, and these were subjected to sensory evaluation on umami, matured flavor, milky richness, creamy texture, and fishy and seaweed flavor. As a result, all were observed to have weak matured flavor, but have umami, milky richness, and creamy texture, have suppressed fishy and seaweed flavor, and have a cheese-like flavor.

### [Preparation 1]

50 parts of hot water-extracted kelp extract, 20 parts of ethanol-extracted kelp extract (containing 41.5% ethanol), 0.1 parts of lipase preparation (Lipase OF Bulk Powder, produced by Meito Sangyo Co., Ltd.), and 29.9 parts of water were mixed, treated with enzyme at 40° C. for 2 hours, and then treated at 80° C. for 10 minutes to deactivate the enzyme, thereby preparing an enzyme-treated kelp extract.

### Example 2

30 g of the enzyme-treated kelp extract of Preparation 1 (Example 2-1) or the kelp extract mixture before lipase was added in Preparation 1 (enzyme-untreated kelp extract) (Example 2-2), 11 g of starch sodium octenyl succinate (Emalstar (registered trademark) 500), 4 g of liquid dextrin (K.D.L. N75C, produced by Japan Corn Starch Co., Ltd.), 3.7 g of salt, and 19.3 g of water were mixed and dissolved, after which 32 g of palm oil (Palm Ace (registered trademark) 10) was added, followed by emulsification using a high-pressure homogenizer (40 MPa), thereby obtaining kelp extract oil-in-water-type emulsions of Example Products 2-1 and 2-2.

### [Evaluation Test 1]

5 wt. % aqueous solutions of Example Products 2-1 and 2-2 were prepared and these were subjected to sensory evaluatation by 9 trained panelists on umami, matured flavor, milkiness (creamy texture), milky richness, and fishy and seaweed flavor. The enzyme-treated kelp extract obtained in Preparation 1 was used as a comparison product. Each evaluation was based on a 5-point scale. The comparison product was assumed as “3”, and results slightly stronger than the comparison product were rated as “4”, results stronger than the comparison product were rated as “5”, results slightly weaker than the comparison product were rated as “2”, and results weaker than the comparison product were rated as “1”, The numerical values of each panelist were averaged and compared with the numerical values of the comparison product. Regarding the umami, matured flavor, milkiness, and milky richness, on the premise that a larger numerical value than that of the comparison product was regarded as superior while a lower numerical value was regarded as inferior, a numerical value of 1.0 or more and less than 2.3 was rated as “Bad”, a numerical value of 2.3 or more and less than 3.6 was rated as “Slightly good”, and a numerical value of 3.6 or more and 5.0 or less was rated as “Good”. The results are shown in Table 1. Regarding the fishy and seaweed flavor, the average value was calculated on the premise that a lower numerical value than that of the comparison product was regarded as superior while a larger numerical value was regarded as inferior. A numerical value of 1.0 or more and less than 2.3 was rated as “Good”, a numerical value of 2.3 or more and less than 3.6 was rated as “Slightly good”, and a numerical value of 3.6 or more and 5.0 or less was rated as “Bad”. The results are shown in Table 1.

TABLE 1

| | Example Product | | Example Product | |
|---|---|---|---|---|
| | 2-1 | | 2-2 | |
| Umami | 4.8 | Good | 3.8 | Good |
| Matured flavor | 4.2 | Good | 2.4 | Slightly good |
| Milkiness (creamy texture) | 4.9 | Good | 4.7 | Good |
| Milky richness | 4.9 | Good | 3.9 | Good |
| Fishy and seaweed flavor | 1.2 | Good | 1.9 | Good |

Compared with the enzyme-treated kelp extract, which was an unemulsified product, the kelp extract oil-in-water-type emulsions of Example Products 2-1 and 2-2 both had stronger umami, creamy texture, and milky richness, had further suppressed fishy and seaweed flavor, and had a cheese-like flavor. Further, the enzyme-treated kelp extract oil-in-water-type emulsions were superior in matured flavor to the unemulsified product.

### Test Example 1

The enzyme-treated kelp extract obtained in Preparation 1, starch sodium octenyl succinate (Emalstar (registered trademark) 500), polyglycerin fatty acid ester (Ryoto (registered trademark) Polyglyester SWA-10D, produced by Mitsubishi Chemical Group Corporation), liquid dextrin (K.D.L. N75C, produced by Japan Corn Starch Co., Ltd.), salt, and water were mixed and dissolved in the ratios shown in Table 2, after which palm oil (Palm Ace (registered trademark) 10) was added, followed by emulsification using a high-pressure homogenizer (40 MPa), thereby obtaining enzyme-treated kelp extract oil-in-water-type emulsified products of Test Products 1-1 to 1-6. Table 2 shows the amount of each raw material.

### [Evaluation Test 2]

5 wt. % aqueous solutions of Test Products 1-1 to 1-6 were prepared, and the presence or absence of oil floating was visually observed. Further, the average particle size of the emulsion particles of Test Products 1-2 to 1-6 was measured by a particle size distribution/particle shape analyzer (produced by MicrotracBEL Corp.). The emulsified products of Test Products 1-2 to 1-6 were emulsions in which water and oil were emulsified; however, in the emulsified product of Test Product 1-1, water and oil remained separated and did not form an emulsion; thus, it was impossible to measure the emulsion particles.

TABLE 2

| | 1-1 | 1-2 | 1-3 | 1-4 | 1-5 | 1-6 |
|---|---|---|---|---|---|---|
| Enzyme-treated kelp extract (%) | 35 | 35 | 35 | 35 | 34 | 34 |
| Starch sodium octenyl succinate (%) | 0 | 6 | 10 | 12 | 15 | 12 |
| Polyglycerin fatty acid ester (%) | 0 | 0 | 0 | 0 | 0 | 3 |
| Palm oil (%) | 30 | 30 | 30 | 30 | 30 | 30 |
| Liquid dextrin (%) | 10 | 7 | 4 | 0 | 0 | 5 |
| Salt (%) | 3.5 | 3.5 | 3.5 | 3.5 | 3.5 | 3.5 |
| Water (%) | 21.5 | 18.5 | 17.5 | 19.5 | 17.5 | 12.5 |
| Kelp extract-derived solids content in | 10.2 | 10.2 | 10.2 | 10.2 | 9.8 | 9.8 |
| emulsion (%) | | | | | | |
| Salt in emulsion (%) | 7.2 | 7.2 | 7.2 | 7.2 | 7.0 | 7.5 |
| Water-soluble polymer compound per part | 0 | 0.20 | 0.33 | 0.40 | 0.50 | 0.40 |
| by weight of fat/oil (parts by weight) | | | | | | |
| Fat/oil per part by weight of kelp extract | 2.9 | 2.9 | 2.9 | 2.9 | 3.1 | 3.1 |
| solids content (parts by weight) | | | | | | |
| Water-soluble polymer compound per part | 0 | 0.59 | 0.98 | 1.2 | 1.5 | 1.2 |
| by weight of kelp extract solids content | | | | | | |
| (parts by weight) | | | | | | |
| Oil floating in 5% solution | Yes | Yes | No | No | Yes | No |
| Average particle size (μm) | — | 8.27 | 1.93 | 1.92 | 3.25 | 1.8 |
| Modal diameter (μm) | — | 1.56 | 1.86 | 1.86 | 2.42 | 1.7 |

The test product containing no starch sodium octenyl succinate, serving as a water-soluble polymer compound, did not give an emulsion, indicating that water and oil were separated. In addition, oil floating was observed in a 5% solution thereof. In contrast, when the amount of starch sodium octenyl succinate was 0.33 parts by weight or 0.4 parts by weight per part by weight of fat/oil, oil floating was not observed after a 5% solution thereof was prepared, and the emulsion particles had a small average particle size, indicating that emulsification was stable. When the amount of starch sodium octenyl succinate was 0.2 parts by weight or 0.5 parts by weight per part by weight of fat/oil, slight oil floating was observed after a 5% solution thereof was prepared, and the emulsion particles had a slightly large average particle size; however, an emulsion was obtained, indicating that an oil-in-water-type emulsion was obtained by containing a water-soluble polymer compound.

### Test Example 2

10 parts of soybean protein hydrolysate (Test Example 2-1) or pea protein hydrolysate (Test Example 2-2), each of which were neutralized with citric acid after hydrolysis with sodium hydroxide, 35 parts of the enzyme-treated kelp extract of Preparation 1, 30 parts of water, and 25 parts of palm oil were emulsified using a high-pressure homogenizer (40 MPa). Alternatively, 12 parts of gum arabic (Instant Gum AA, produced by Nexira) (Test Example 2-3), 4 parts of liquid dextrin (K.D.L. N75C), 32 parts of the enzyme-treated kelp extract of Preparation 1, 3.6 parts by weight of salt, 18.4 parts of water, and 30 parts of palm oil were emulsified using a high-pressure homogenizer (40 MPa). In Test Examples 2-1 and 2-2, which used plant protein hydrolysates, enzyme-treated kelp extract oil-in-water-type emulsions (Test Products 2-1 and 2-2) were obtained; however, in Test Example 2-3, which used gum arabic, emulsification itself was difficult, and no emulsion was obtained.

5 wt. % aqueous solutions of Test Products 2-1 and 2-2 were prepared, and the presence or absence of oil floating were visually observed. As a result, neither of them were observed to show oil floating, indicating that they were oil-in-water-type emulsions with excellent emulsion stability.

### Example 3

3% of Example Product 2-1 was added to a commercially available cheese-like food made based on plant-derived raw materials (Vegan Shred, produced by Marinfood Co., Ltd.). As a result, compared to pre-addition, the umami and richness from mid-taste to aftertaste were enhanced, the overall taste was mellow, and umami as if real cheese were eaten was felt.

The addition of the oil-in-water-type emulsion of Example Product 2-1 enhanced the richness and umami of the cheese-like food made based on plant-derived raw materials, resulting in a cheese-flavored food with an enhanced cheese-like flavor, and indicating that the oil-in-water-type emulsion of Example Product 2-1 was beneficial as a seasoning.

### Example 4

2% of the oil-in-water-type emulsified seasoning of Example Product 2-1 was added to a soy milk-based confectionery filling. As a result, compared to pre-addition, the resulting filling was observed to have a rich cheese-like flavor and enhanced rich umami.

### Example 5

Soy milk of Example Product 5 was prepared by adding 2% of the oil-in-water-type emulsified seasoning of Example Product 2-1 to unadjusted soy milk, and the following Evaluation Test 3 was performed. Instead of Example Product 2-1, 0.14% of salt was added to prepare soy milk in which the salt concentration was adjusted as in Example Product 5, which was used as a comparison product.

### [Evaluation Test 3]

Example Product 5 was subjected to sensory evaluation by 11 trained panelists on umami, milkiness (creamy texture), richness, and soybean smell. Each evaluation was based on a 5-point scale. The comparison product was assumed as “3”, and results slightly stronger than the comparison product were rated as “4”, results stronger than the comparison product were rated as “5”, results slightly weaker than the comparison product were rated as “2”, and results weaker than the comparison product were rated as “1”. The numerical values of each panelist were averaged and compared with the numerical values of the comparison product. Regarding the umami, milkiness (creamy texture), and richness, on the premise that a larger numerical value than that of the comparison product was regarded as superior while a lower numerical value was regarded as inferior, a numerical value of 1.0 or more and less than 2.3 was rated as “Bad”, a numerical value of 2.3 or more and less than 3.6 was rated as “Slightly good”, and a numerical value of 3.6 or more and 5.0 or less was rated as “Good”. The results are shown in Table 3. Regarding the soybean smell, the average value was calculated on the premise that a lower numerical value than that of the comparison product was regarded as superior while a larger numerical value was regarded as inferior. A numerical value of 1.0 or more and less than 2.3 was rated as “Good”, a numerical value of 2.3 or more and less than 3.6 was rated as “Slightly good”, and a numerical value of 3.6 or more and 5.0 or less was rated as “Bad”. The results are shown in Table 3.

TABLE 3

Example Product 5

| | | |
|---|---|---|
| Umami | 4.3 | Good |
| Milkiness (creamy texture) | 4.5 | Good |
| Richness | 4.6 | Good |
| Soybean smell | 1.8 | Good |

It was found that the use of the oil-in-water-type emulsified seasoning of Example Product 2-1 could enhance the umami, milkiness, and richness of the soy milk, and further could mask bean smell.

### Example 6

White broth soups of Example 6 and a comparative example using plant raw materials were prepared with the formulations shown in Table 4, and the following Evaluation Test 4 was performed. The resulting white broth soup of Example Product 6 contained 4.5% of the oil-in-water-type emulsified seasoning of Example Product 2-1, and a total of 0.68% of salt was added to the comparison product so that the salt concentration was the same as that of Example Product 6.

TABLE 4

| | Comparative | Example |
|---|---|---|
| | Example (%) | 6 (%) |
| Protein hydrolysate | 3.20 | 3.20 |
| Sugars | 1.70 | 1.70 |
| Fermented seasoning | 0.52 | 0.52 |
| Salt | 0.68 | 0.35 |
| Vegetable extract | 0.35 | 0.35 |
| Kelp extract | 0.16 | 0.16 |
| Miso | 0.10 | 0.10 |
| Yeast powder | 0.05 | 0.05 |
| Plant fat/oil | 0.04 | 0.04 |
| Spices | 0.01 | 0.01 |
| Seasonings | 0.05 | 0.05 |
| (amino acids etc.) | | |
| Flavoring | 0.01 | 0.01 |
| Example Product 2-1 | 0 | 4.50 |
| Water | 93.13 | 88.96 |

### [Evaluation Test 4]

Example Product 6 was subjected to sensory evaluation by 6 trained panelists on umami, milkiness (creamy texture), richness, meaty flavor, and cloudiness. Each evaluation was based on a 5-point scale. The comparison product was assumed as “3”, and results slightly stronger than the comparison product were rated as “4”, results stronger than the comparison product were rated as “5”, results slightly weaker than the comparison product were rated as “2”, and results weaker than the comparison product were rated as “1”. The numerical values of each panelist were averaged and compared with the numerical values of the comparison product. On the premise that a larger numerical value than that of the comparison product was regarded as superior while a lower numerical value was regarded as inferior, a numerical value of 1.0 or more and less than 2.3 was rated as “Bad”, a numerical value of 2.3 or more and less than 3.6 was rated as “Slightly good”, and a numerical value of 3.6 or more and 5.0 or less was rated as “Good”. The results are shown in Table 5.

TABLE 5

Example Product 6

| | | |
|---|---|---|
| Umami | 4.5 | Good |
| Milkiness (creamy texture) | 5.0 | Good |
| Richness | 4.7 | Good |
| Meaty flavor | 4.3 | Good |
| Cloudiness | 5.0 | Good |

It was found that the use of the oil-in-water-type emulsified seasoning of Example Product 2-1 could enhance the umami, milkiness, richness, meaty flavor, and cloudiness of the white broth soup made of plant raw materials.

### Example 7

Caramel raw materials of Example 7 and a comparative example using plant raw materials were prepared with the formulations shown in Table 6, and then boiled down until the total weight was reduced to 50% weight, thereby preparing caramels of Example Product 7 and a comparison product, and the following Evaluation Test 5 was performed. 2% of the oil-in-water-type emulsified seasoning of Example Product 2-1 was added to the caramel raw materials.

TABLE 6

| | Comparative Example (%) | Example 7 (%) |
|---|---|---|
| Unadjusted soy milk | 36.9 | 36.9 |
| Plant fresh cream | 34.9 | 34.9 |
| Caster sugar | 21.0 | 21.0 |
| Plant butter | 7.0 | 7.0 |
| Caramel | 0.1 | 0.1 |
| Flavoring | 0.1 | 0.1 |
| Example Product 2-1 | 0 | 2.0 |

### [Evaluation Test 5]

Example Product 7 was sensorily evaluated by 5 trained panelists for milkiness (creamy texture), richness, smoothness, and soybean smell. Each evaluation was based on a 5-point scale. The comparison product was assumed as “3”, and regarding the milkiness (creamy texture), richness, and soybean smell, results slightly stronger than the comparison product were rated as “4”, results stronger than the comparison product were rated as “5”, results slightly weaker than the comparison product were rated as “2”, and results weaker than the comparison product were rated as “1”. Regarding the smoothness, results slightly smoother than the comparison product were rated as “4”, results smoother than the comparison product were rated as “5”, results not slightly smoother than the comparison product were rated as “2”, and results not smoother than the comparison product were rated as “1”. The numerical values of each panelist were averaged and compared with the numerical values of the comparison product. Regarding the milkiness (creamy texture), richness, and smoothness, on the premise that a larger numerical value than that of the comparison product was regarded as superior while a lower numerical value was regarded as inferior, a numerical value of 1.0 or more and less than 2.3 was rated as “Bad”, a numerical value of 2.3 or more and less than 3.6 was rated as “Slightly good”, and a numerical value of 3.6 or more and 5.0 or less was rated as “Good”. The results are shown in Table 7. Regarding the soybean smell, the average value was calculated on the premise that a lower numerical value than that of the comparison product was regarded as superior while a larger numerical value was regarded as inferior. A numerical value of 1.0 or more and less than 2.3 was rated as “Good”, a numerical value of 2.3 or more and less than 3.6 was rated as “Slightly good”, and a numerical value of 3.6 or more and 5.0 or less was rated as “Bad”. The results are shown in Table 7.

TABLE 7

Example Product 7

| | | |
|---|---|---|
| Milkiness (creamy texture) | 4.6 | Good |
| Richness | 4.6 | Good |
| Smoothness | 4.1 | Good |
| Soybean smell | 1.4 | Good |

It was found that the use of the oil-in-water-type emulsified seasoning of Example Product 2-1 could enhance the milkiness, richness, and smoothness of the caramel made of plant raw materials, and further could mask bean smell.

1. A method for producing an oil-in-water-type emulsified seasoning, the method comprising:
emulsifying a kelp extract and fat/oil in the presence of a water-soluble polymer compound.

2. The method according to claim 1, wherein the oil-in-water-type emulsified seasoning comprises from 0.1 to 10 parts by weight of the fat/oil per part by weight of solids content in the kelp extract.

3. The method according to claim 1, wherein the oil-in-water-type emulsified seasoning comprises from 0.05 to 5 parts by weight of the water-soluble polymer compound per part by weight of the fat/oil.

4. The method according to claim 1, wherein the oil-in-water-type emulsified seasoning comprises from 5 to 30 wt. % of the water-soluble polymer compound per 100 wt. % of the oil-in-water-type emulsified seasoning.

5. An oil-in-water-type emulsified seasoning, comprising: a kelp extract, fat/oil, and a water-soluble polymer compound.

6. The oil-in-water-type emulsified seasoning according to claim 5, which comprises from 0.1 to 10 parts by weight of the fat/oil per part by weight of solids content in the kelp extract.

7. The oil-in-water-type emulsified seasoning according to claim 5, which comprises from 0.05 to 5 parts by weight of the water-soluble polymer compound per part by weight of the fat/oil.

8. The oil-in-water-type emulsified seasoning according to claim 5, which comprises from 5 to 30 wt. % of the water-soluble polymer compound per 100 wt. % of the oil-in-water-type emulsified seasoning.

9. A method for producing plant food and/or drink, the method comprising: introducing the oil-in-water-type emulsified seasoning according to claim 5 into the plant food and/or drink.

10. A method for imparting enhanced umami, imparting enhanced cheese flavor, imparting enhanced cloudiness, imparting enhanced milkiness, imparting enhanced richness, imparting enhanced meaty flavor, imparting enhanced smoothness, or masking, the method comprising: introducing the oil-in-water-type emulsified seasoning according to claim 5.

11. A food and/or drink, comprising: the oil-in-water-type emulsified seasoning according to claim 5.

12. A plant food and/or drink, comprising: the oil-in-water-type emulsified seasoning according to claim 5.

13. A cheese flavor food and/or drink, a milk flavor food and/or drink, or an emulsified soup and sauce, each comprising: the oil-in-water-type emulsified seasoning according to claim 5.
